(19) United States
(12) Patent Application Publication
(10) Pub. No.: US 2004/0151469 A1
(43) Pub. Date: Aug. 5, 2004

(54) Video editing timeline with measurement results

(76) Inventors: Kathryn A. Engholm, Beaverton, TN (US); Bozidar Janko, Portland, OR (US)

Correspondence Address: Tektronix, Inc., Francis I. Gray, MS 50-LAW, P.O. Box 500, Beaverton, OR, 97077, US

(21) Appl. No.: 10/355,391

(22) Filed: Jan. 31, 2003

(51) Int. Cl. H04N 5/76; G11B 27/00

(52) U.S. Cl. 386/52; 386/64

(57) ABSTRACT

A video editing timeline is displayed that includes a measurement track. Audio/video content is processed by an appropriate measurement algorithm to produce measurement results. The measurement results are encoded in a standard editing file format, such as .wav, to produce a measurement file. The measurement file is stored with other editing content files and processed by a video editing software application. The measurement file is output as the measurement track on the video editing timeline, with different visual indicia for “close to out of limit” errors and for “out of limit” errors. When a show represented by the editing timeline is played, both the visual indicia and audible indicia are included so a user can hear when “close to out of limits” and “out of limits” errors occur. The audible indicia may be different types of tones or actual synthesized speech words.

### BACKGROUND OF THE INVENTION

The present invention relates to the display of video/audio measurement results, and more particularly to the display of video/audio measurement results in a video editing timeline.

Video editing applications allow operators to create and modify “shows” consisting of video and audio tracks, such as movies, DVDs, advertisements, television programs, etc. Such shows may include graphics, photographs and other media types. The content these applications produce is often tested or measured in order to verify that it is legal for transmission in a particular video format, such as composite NTSC. Other reasons for such testing or measuring is to assure that the exact color is shown for a brand logo, to insure that the same scene looks the same in different video clips, etc.

The most common way to make these measurements is to connect a measurement instrument, such as a waveform monitor, vectorscope, etc., to the signal at some point in the video editing system where it is present as a physical signal. Increasingly software-only measurement tools are becoming available to make similar measurements on the content while it is still “inside the computer” in the editing application.

A key limitation of these current methods is that the measurement results are “live” and reflect only the current state of the video frame, line or other unit of content being tested. Users would like the measurements, or at least detected errors, to be logged for a longer time period so the users can test a section of content but not review the results until some later time. In other words the users want to be able to test a show without staring unflinchingly at some measurement graph for two hours.

Additionally if the measurement tool creates a results log, users want those results ported into their main visualization and management tool—the Timeline. This allows the users to quickly see when the problems are and to go to the exact location in the content for further examination or correction. While creating a log and perhaps even time-stamping it to match the show is straightforward, a means for integrating this data into the editing application does not currently exist. None of the existing editing applications, including Avid Symphony, Adobe Premier, Apple FinalCutPro, etc., make any provisions for importing measurement data or for displaying it in their timelines. To do so could involve lengthy negotiations and development of unique formats and commands for each editing application.

What is desired is a measurement tool that provides data for the timeline of practically any editing application, including video and audio indications.

### BRIEF SUMMARY OF THE INVENTION

Accordingly the present invention provides a measurement tool for video editing applications that places measurement results in a timeline with visual and audible indications. A video editing timeline is displayed that includes a measurement track. Audio/video content is processed by an appropriate measurement algorithm to produce measurement results. The measurement results are encoded in a standard editing file format, such as .wav, to produce a measurement file. The measurement file is stored with other editing content files and processed by a video editing software application. The measurement file is output as the measurement track on the video editing timeline, with different visual indicia for “close to out of limit” errors and for “out of limit” errors. When a show represented by the editing timeline is played, both the visual indicia and audible indicia are included so a user also can hear when “close to out of limits” and “out of limits” errors occur. The audible indicia may be different types of tones or actual synthesized speech words.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a logic block diagram view of a measurement tool for use in an editing application according to the present invention.

FIG. 2 is a plan view of an editing timeline including measurement results according to the present invention.

FIG. 3 is a waveform view of a measurement track on the editing timeline illustrating a zoom function according to the present invention.

### DETAILED DESCRIPTION OF THE INVENTION

The method described below is to encode measurement results into a file of a standard format already compatible with editing Timelines. These standard formats include .wav (audio), .avi (video), .jpg (photo), etc. For the following description .wav format is used since it is compact, simple to create and provides both visual and audio feedback to a user in an editing application.

A typical error a user may want to log is “out of gamut”, meaning that there is a color in the video frame that is not reproducible by a target recipient, such as a standard television set. Assume that the user has just completed editing a show and wants to check for this problem throughout the entire show. The editing application plays the show, and the measurement tool monitors it from start to finish. For each error that the measurement tool detects, it logs the error with a timestamp and perhaps other data of interest to the user. This error data is converted into an audio signal with meaningful sounds coded into the audio file at times corresponding to the errors. For example a quiet, mid-frequency tone may indicate that the video track contained colors close to the gamut limit, while a loud, high-pitched squeal may signify a serious error or “alarm.” Alternatively a speech signal may be inserted instead of a tone, saying “Caution” or “Alarm” at the appropriate times.

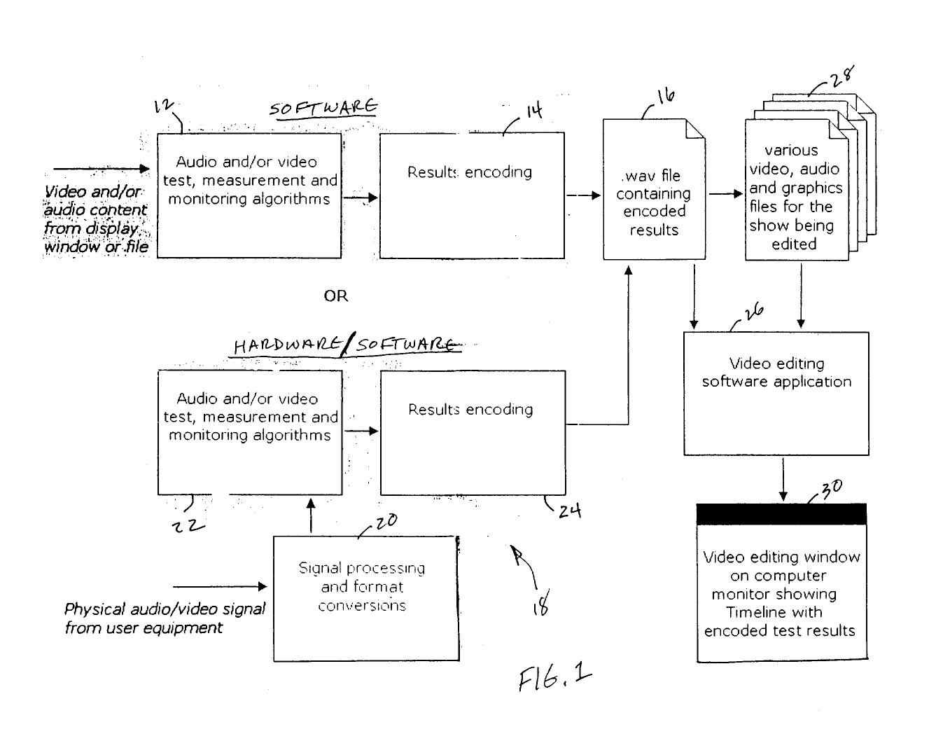

Referring now to FIG. 1 both a software and combination hardware/software implementation are shown. For the software implementation running on a host computer together with the editing application, video and/or audio content from a display window or file, such as disclosed in pending U.S. patent application Ser. No. ______ [DF7388], is input to an audio and/or video test, measurement and monitoring algorithms module 12 to produce measurement results. The measurement results are then input to a results encoding module 14 to convert the measurement results to a standard editing file format 16, such as .wav.

Likewise for the hardware/software implementation a physical audio/video signal from a user's equipment is input to a test instrument 18, such as a waveform monitor, vectorscope or the like. The test instrument 18 includes a signal processing and format converter 20 to change the format of the audio/video content to one appropriate for the test instrument. The resulting reformatted content is then processed by an appropriate test, measurement and monitoring algorithm 22 to produce measurement results which are then processed by a results encoder 24 to transform the measurement results to a standard editing file format 16, such as .wav.

The measurements file is then transferred to a video editing host computer or network 26 and stored together with other audio/video/graphic content files 28. The measurement file together with the video, audio and graphics content files 28 are input by a video editing software application running on the host computer or network 26 to a video editing window 30 on a display monitor as part of an editing timeline.

The measurement file is saved, as a .wav file in this example, with the other edit content files 28, as indicated above. Within the editing application the user selects the measurement file and adds it to the Timeline, or updates it if it is already there, in a familiar manner. Now the measurement file is visible as an audio waveform with its amplitude and frequency variations indicating the recorded errors. When the user plays the show, the measurement file is audible, alerting the user to errors even if he/she isn't watching the display monitor at the time.

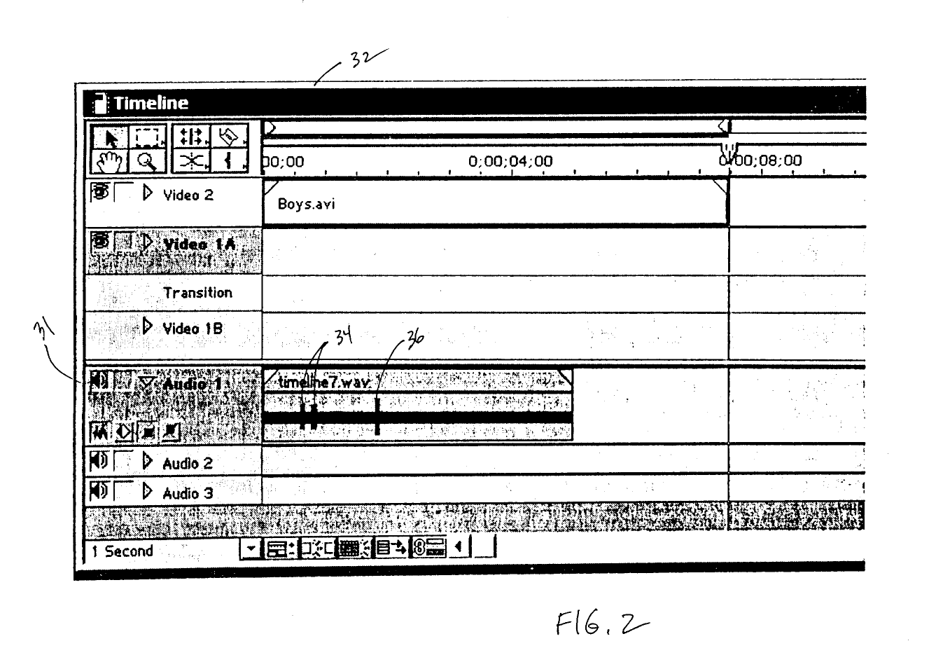

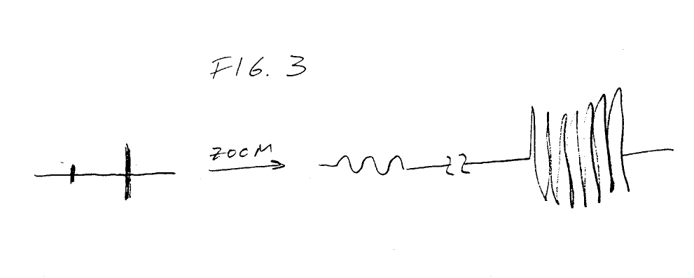

As shown in FIG. 2 the measurement results are shown in the “Audio 1” track 31 of an editing timeline 32 on a display monitor. Two cautionary errors 32 occur near the beginning of the measurement track 31, as indicated by the lower amplitude marks in the timeline, and a more serious alarm occurs shortly before the middle of the file, as indicated by the large amplitude mark. These are easily visible. Additionally by zooming the time scale of the timeline, the user is able to see that the caution indicators are of lower frequency or different shape than the alarm indicator, as shown in FIG. 3. When a PLAY button (not shown) is pressed, the sounds of the measurement track are heard along with the sounds from any other audio tracks being played out with the selected segment of the video track.

The process of initiating measurements and displaying/playing the results in the editing application Timeline may be automated, rather than having the user run the tools individually and then manually add the measurement track to the Timeline. This functionality may be dependent on the capabilities of the specific editing application. For instance a particular editing application may support realtime updates to a linked .wav file. Alternatively the editing application may have a command to launch measurement logging.

Thus the present invention provides a visual and audible indication of measurement results in an editing application Timeline by converting measurement results to a standard audio file format that may be selected by the editing application as an audio track on the Timeline.

What is claimed is:

1. A method of indicating audio/video content measurement results in an editing application Timeline comprising the steps of:
encoding the measurement results in a standard editing file format to provide a measurement file; and
displaying the measurement file in the editing application Timeline as a measurement track.

2. The method as recited in claim 1 wherein the measurement track comprises a visual cautionary indicator and a visual alarm indicator for measurement results that are “close to out of limits” and for measurement results that are “out of limits” respectively.

3. The method as recited in claims 1 or 2 further comprising the step of providing an audible indicator of errors from the measurement file as detected by the measurement results such that when a show represented by the Timeline is played, a user is audibly alerted to the errors.

4. The method as recited in claim 3 wherein the audible indicator comprises a quiet, low-frequency tone when the measurement results are “close to out of limits” and a loud, high-frequency tone when the measurement results are “out of limits.”

5. The method as recited in claim 3 wherein the audible indicator comprises a first speech word when the measurement results are “close to out of limits” and a second speech word when the measurement results are “out of limits.”
